(19) United States
(12) Patent Application Publication
(10) Pub. No.: US 2008/0188778 A1
(43) Pub. Date: Aug. 7, 2008

(54) Array percutaneous therapeutic apparatus

(76) Inventor: Yu-Yu Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/010,903

(22) Filed: Jan. 31, 2008

(30) Foreign Application Priority Data
Feb. 2, 2007 (TW) 96103879
Aug. 10, 2007 (TW) 96213219

(51) Int. Cl. A61H 1/00

(52) U.S. Cl. 601/15

(57) ABSTRACT

An array percutaneous therapeutic apparatus includes a holder having an insertion face; a plurality of percutaneous therapeutic units separately inserted on the insertion face of the holder; a belt connected to two lateral ends of the holder for binding the holder to the user's body with the percutaneous therapeutic units inserted on the holder contacting with the user's skin at selected areas, so that the percutaneous therapeutic units may output therapeutic energy to the selected areas; and a control circuit for controlling the percutaneous therapeutic units to operate, so that the percutaneous therapeutic units output the therapeutic energy to the selected areas on the user's body by turns in a preset sequence.

### FIELD OF THE INVENTION

The present invention relates to a percutaneous therapeutic apparatus, and more particularly to an array percutaneous therapeutic apparatus.

### BACKGROUND OF THE INVENTION

In the conventional heat therapy for treating aches at bones and muscles caused by sports injury, the injured areas are either covered with a hot towel, soothed with steam, or immersed in hot water. However, with the above conventional ways of heat therapy, heat can only be transferred to the user's skin without deeply reaching at the user's muscles and bones, and cannot generate good treatment effect, particularly in the case of osteoarthritis.

There is developed an ultrasonic therapeutic transducer that employs the principle of ultrasonic resonance to transfer heat deeply to the user's bones and muscles. The ultrasound can transfer into deep tissue and transform as heat and accelerate blood circulation and promote skin metabolism. The ultrasonic therapeutic transducer also helps in the oozing of a medicament applied on the user's skin to muscles and bones to achieve the therapeutic effect. Taiwan Patent No. 00140339 granted in 1990 discloses a percutaneous drug dispenser and electrodes thereof. The percutaneous drug dispenser is characterized by having at least two electrode elements spaced from one another by insulating means, a storing means located in at least one of the electrode elements and having a predetermined drug stored therein, and a circuit including a power supply. Taiwan Patent No. 00199865 granted in 1993 discloses a percutaneous electrode structure and a percutaneous medicament transfer device using the percutaneous electrode structure, being characterized in that the percutaneous medicament transfer device includes an electrode, a porous insulating layer located at one side of the electrode and permeated with a medical liquid to be transferred, a liquid storing means located at the other side of the electrode, and a displaceable membrane for controlling the feeding of the medical liquid from the liquid storing means via the electrode to the porous insulating layer. Therefore, the conventional percutaneous therapeutic apparatus use either ultrasonic wave or electrode to perform percutaneous therapy on a user's body.

The currently available percutaneous therapeutic apparatus all include only one single ultrasonic generating unit or electrode. The only one single ultrasonic generating unit or electrode must not be held to the user's skin for an excessively long time, lest the user's skin should be overheated and injured by the heat energy from the ultrasonic wave generating unit or the electrode. To avoid overheating and injuring the user's skin, the user must frequently move the ultrasonic wave generating unit or the electrode over skin, such that heat is uniformly distributed to the injured region. Generally, the user holds the ultrasonic wave generating unit with his hand and keeps his hand constantly moving around the injured region. At the end of the treatment, the user's hand is often tired from holding and moving the device. This discomfort makes the user reluctant to use the ultrasonic wave generating unit. Meanwhile, during the treatment, the user has to keep watch to any pain or discomfort at the treated area possibly caused by excessive ultrasonic energy or conducted electric energy.

Many studies show that electrical stimulation to physical body causes polarization effect, which would decrease as time progresses. In other words, the response of human body to an electrical stimulation would reduce as time goes on. The reduction of effect is due to polarization at body cells. In order to provide efficient stimulation, the ultrasonic wave generating unit or the electrode is designed to generate periodic electrical stimulation. For each cycle, the ultrasonic wave generating unit is on for 10% to 60% of cycle time and then off for the rest of the time. Accordingly, the ultrasonic wave generating unit cannot be fully utilized

Therefore, the conventional percutaneous therapeutic apparatus with only one single percutaneous unit is not convenient for use.

### SUMMARY OF THE INVENTION

A primary object of the present invention is to provide a percutaneous therapeutic apparatus including a plurality of percutaneous therapeutic units that separately output therapeutic energy to different areas on a user's body in a preset sequence, so as to avoid the problem of overheating and injuring the user's skin during the therapy.

Another object of the present invention is to provide a percutaneous therapeutic apparatus that includes a belt for binding an array of percutaneous therapeutic units of the apparatus to selected areas on the user's body, so that a user does not need to troublesomely manually move the percutaneous therapeutic apparatus over the user's body.

To fulfill the above objects, the present invention provides an array percutaneous therapeutic apparatus. The array percutaneous therapeutic apparatus includes a holder having an insertion face; a plurality of percutaneous therapeutic units separately inserted on the insertion face of the holder; a belt connected to two lateral ends of the holder for binding the holder to the user's body with the percutaneous therapeutic units inserted on the holder contacting with the user's skin at selected areas, so that the percutaneous therapeutic units may output therapeutic energy to the selected areas; and a control circuit for controlling the percutaneous therapeutic units to operate, so that the percutaneous therapeutic units output the therapeutic energy to the selected areas on the user's body by turns in a preset sequence.

With the technical means provided by the present invention, a plurality of percutaneous therapeutic units are caused to output therapeutic energy to selected areas on a user's body by turns without the problem of overheating and injuring the user's skin, and the percutaneous therapeutic apparatus of the present invention does not require the user to troublesomely manually move the apparatus over the user's body. It would not cause fatigue to the user's hand, and overheating due to slow motion of the user's hand can be avoided.

Moreover, because the operation of the percutaneous therapeutic apparatus is controlled by the control circuit, the working time of each percutaneous therapeutic unit to each selected area is precisely controlled, and no overheating would be caused.

Furthermore, since the percutaneous therapeutic units are output to selected areas at predetermined intervals and in the sequence as preset, no area would receive continuous stimulation, and hence polarization would not happen. As a result, the electrical stimulation to body cell can be fully effected.

And, the configuration of the percutaneous therapeutic apparatus allows a plurality of percutaneous therapeutic units to be programmed to output to selected areas at predetermined intervals and in the sequence as preset. Hence the percutaneous therapeutic apparatus enables a comparatively larger region to be treated at the same time. It is more efficient and time saving for treating large region.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a percutaneous therapeutic apparatus according to the present invention;

FIG. 2 is a perspective view showing a plurality of percutaneous therapeutic units for the present invention being inserted on a holder;

FIG. 3 is a front view of FIG. 2;

FIG. 4 is a top view of FIG. 2;

FIG. 5 is a block diagram showing a first control circuit for the present invention;

FIG. 6 is a block diagram showing a second control circuit for the present invention;

FIG. 7 is a block diagram showing a first embodiment of the present invention adopting the first control circuit of FIG. 5;

FIG. 8 is a block diagram showing the first embodiment of the present invention adopting the second control circuit of FIG. 6;

FIG. 9 is a block diagram showing a second embodiment of the present invention adopting the first control circuit of FIG. 5; and

FIG. 10 is a block diagram showing the second embodiment of the present invention adopting the second control circuit of FIG. 6.

### DETAILED DESCRIPTION OF THE PREFERRED EMBODIMENTS

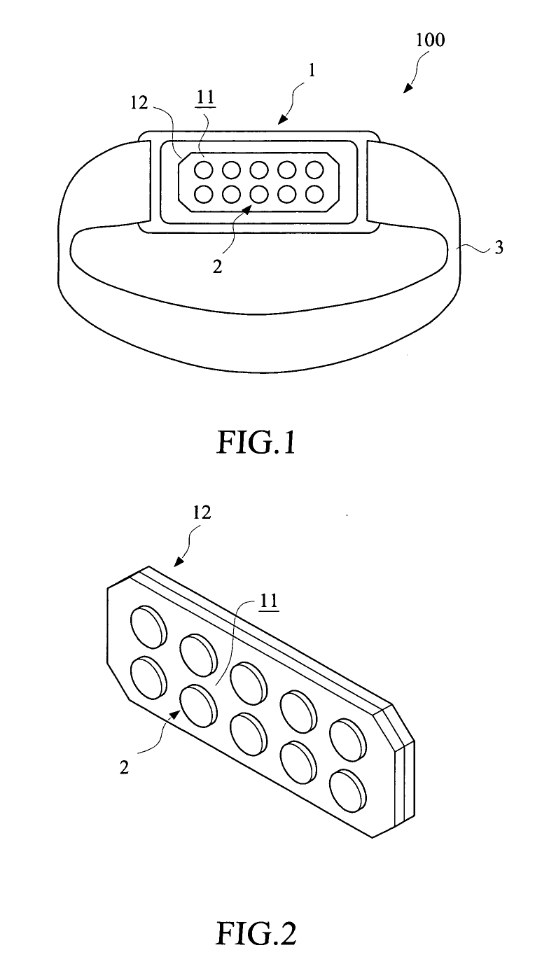

Please refer to FIG. 1. A percutaneous therapeutic apparatus 100 according to the present invention includes a holder 1, an array of percutaneous therapeutic units 2, and a belt 3. The holder 1 includes an insertion face 11, on which the array of percutaneous therapeutic units 2 is inserted.

The belt 3 is connected to two lateral ends of the holder 1 for binding the holder 1 of the percutaneous therapeutic apparatus 100 to a user's body with the array of percutaneous therapeutic units 2 inserted on the holder 1 fitly located at and in contact with selected areas on the user's body, so that the array of percutaneous therapeutic units 2 may output therapeutic energy to those selected areas. Preferably, the holder 1 is made of a flexible material, such as polyurethane (PU), silicone, rubber, non-woven fabric, woven fabric, paper, etc., so that the holder 1 may be fitly bound to the user's joints, bendable portions, or any other areas, allowing the percutaneous therapeutic apparatus 100 to be conveniently and comfortably worn on the user's body. Meanwhile, the belt 3 may be elastic or adjustable in length.

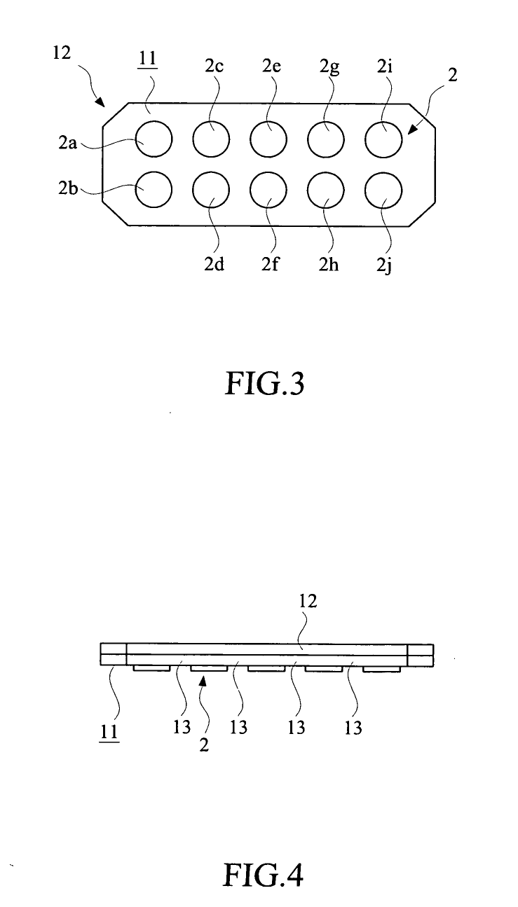

Please refer to FIGS. 2 to 4 at the same time. The array of percutaneous therapeutic units 2 includes a plurality of percutaneous therapeutic units, in the illustrated embodiments there are shown ten units 2a to 2j, being separately inserted on the insertion face 11 of the holder 1. In the illustrated embodiments, the holder 1 also includes a holding section 12. The array of percutaneous therapeutic units 2 is held to the holding section 12 and upward projected from the insertion face 11 for directly contacting with the skin at the selected areas on the user's body and outputting the therapeutic energy to the selected areas.

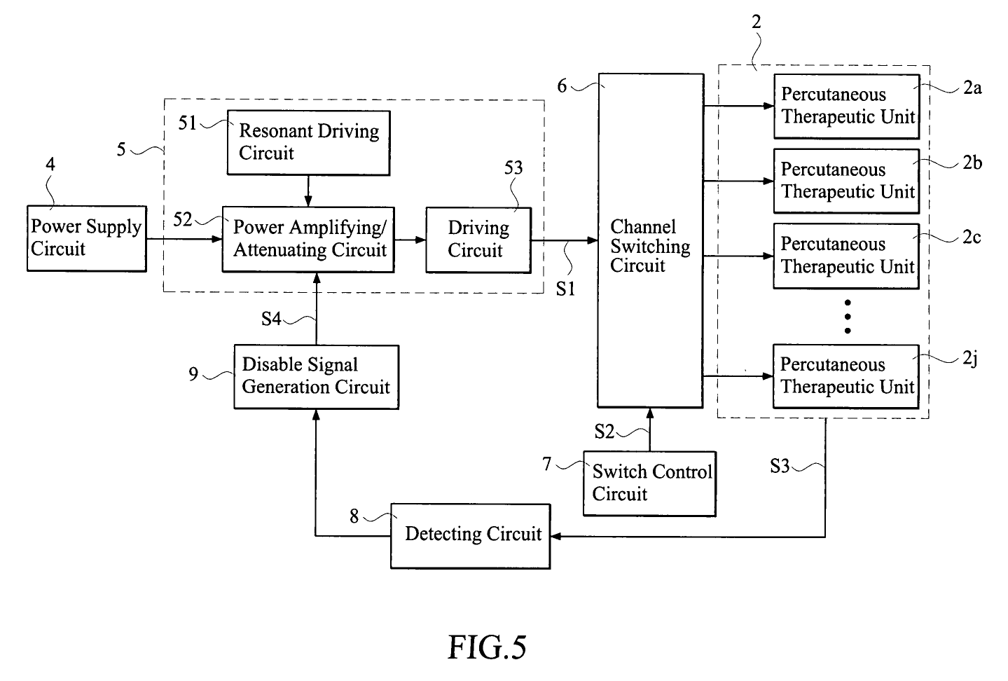

FIG. 5 is a block diagram showing a first control circuit for the present invention. As shown, the first control circuit includes a therapeutic energy signal generation circuit 5, a channel switching circuit 6, a switch control unit 7, a detecting circuit 8, and a disable signal generation circuit 9.

The therapeutic energy signal generation circuit 5 includes a resonant driving circuit 51, a power amplifying/attenuating circuit 52, and a driving circuit 53. The array of percutaneous therapeutic units 2 is connected to the driving circuit 53 via the channel switching circuit 6. The resonant driving circuit 51 generates a resonant signal to the power amplifying/attenuating circuit 52. The power amplifying/attenuating circuit 52 is connected to a power supply 4 for regulating the power supplied by the power supply 4, and generating a driving signal to the driving circuit 53. The driving circuit 53 generates a therapeutic energy output signal S1 to drive one of the percutaneous therapeutic units 2a, 2b, 2c . . . , or 2j via the channel switching circuit 6 for the driven percutaneous therapeutic unit to output therapeutic energy.

The channel switching circuit 6 is connected to and between the driving circuit 53 and the array of percutaneous therapeutic units 2 for controlling the percutaneous therapeutic units 2a to 2j to operate in a preset sequence. The switch control unit 7 is connected to the channel switching circuit 6 for setting operation intervals and sequence of the percutaneous therapeutic units 2a to 2j as well as the number of percutaneous therapeutic units to be driven to operate each time; and generating a switch control signal S2 to the channel switching circuit 6 for controlling the channel switching circuit 6, so that the percutaneous therapeutic units 2a to 2j are driven to operate at the intervals and in the sequence as preset via the switch control unit 7 to output the therapeutic energy. Therefore, the percutaneous therapeutic apparatus 100 of the present invention is more convenient for use compared to the conventional percutaneous therapeutic apparatus that requires a user to troublesomely manually move the only one percutaneous therapeutic unit to different areas on the skin.

The detecting circuit 8 is connected to each of the percutaneous therapeutic units 2a to 2j, and to the disable signal generation circuit 9. The disable signal generation circuit 9 is connected to the power amplifying/attenuating circuit 52 of the therapeutic energy signal generation circuit 5 and to the detecting circuit 8. As having been mentioned above, the percutaneous therapeutic units 2a to 2j contact with the selected areas on the user's skin and output therapeutic energy thereto by turns. When any one of the percutaneous therapeutic units 2a to 2j is overheated, an overheating signal S3 would be generated by the overheated percutaneous therapeutic unit to the detecting circuit 8, which will then transfer the received overheating signal S3 to the disable signal generation circuit 9. On receipt of the overheating signal S3, the disable signal generation circuit 9 will generate a disable signal generation signal S4 to the therapeutic energy generation circuit 5, so that the therapeutic energy signal generation circuit 5 stops generating the therapeutic energy output signal S1.

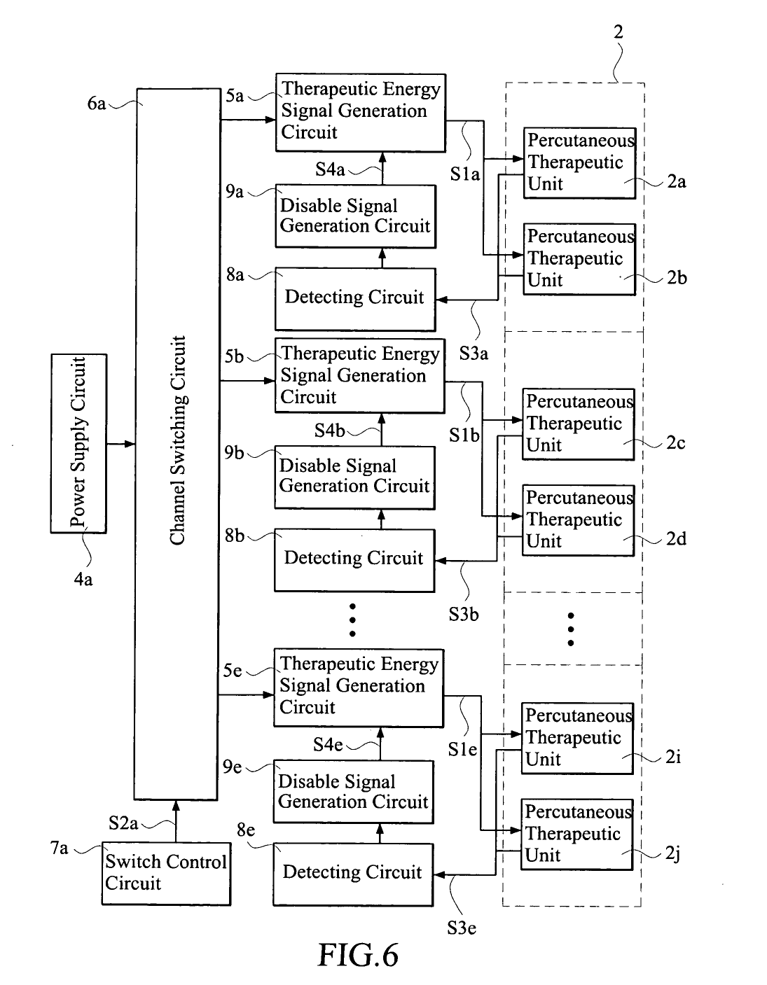

FIG. 6 is a block diagram showing a second control circuit for the present invention. As shown, the second control circuit includes a power supply 4a, a plurality of therapeutic energy signal generation circuits 5a to 5e, a channel switching circuit 6a, a switch control unit 7a, a plurality of detecting circuits 8a to 8e, and a plurality of disable signal generation circuits 9a to 9e. The therapeutic energy signal generation circuits 5a to 5e are respectively connected to one group of two percutaneous therapeutic units 2a and 2b, 2c and 2d, 2e and 2f, 2g and 2h, and 2i and 2j for generating a therapeutic energy output signal S1a to S1e to drive the percutaneous therapeutic units 2a and 2b, 2c and 2d, 2e and 2f, 2g and 2h, and 2i and 2j to output therapeutic energy. The therapeutic energy signal generation circuits 5a to 5e are similar to the therapeutic energy signal generation circuit 5 shown in FIG. 5, and each include a resonant driving circuit, a power amplifying/attenuating circuit, and a driving circuit. The therapeutic energy output signals S1a to S1e are generated by the driving circuits of the therapeutic energy signal generation circuits 5a to 5e, respectively.

The channel switching circuit 6a is connected to and between the power supply 4a and each of the therapeutic energy signal generation circuits 5a to 5e. The switch control unit 7a is connected to the channel switching circuit 6a for setting intervals and sequence for the channel switching circuit 6a to switch among the therapeutic energy signal generation circuits 5a to 5e, and generating a switch control signal S2a to the channel switching circuit 6a for controlling the same, so that the power supply 4a may supply a working voltage to each of the therapeutic energy signal generation circuits 5a to 5e at the switching intervals and in the switching sequence as preset via the switch control unit 7a.

The detecting circuit 8a is connected to the percutaneous therapeutic units 2a, 2b and to the disable signal generation circuit 9a. The disable signal generation circuit 9a is connected to the therapeutic energy signal generation circuit 5a and the detecting circuit 8a. When the percutaneous therapeutic units 2a, 2b are overheated, an overheating signal S3a is output to the detecting circuit 8a. The detecting circuit 8a would then transfer the received overheating signal S3a to the disable signal generation circuit 9a, which in turn generates a disable signal generation signal S4a to the therapeutic energy signal generation circuit 5a for the latter to stop generating the therapeutic energy output signal S1a. Other detecting circuits 8b to 8e, disable signal generation circuits 9b to 9e, therapeutic energy signal generation circuits 5b to 5e, and percutaneous therapeutic units 2c to 2j have connection relation and working manner similar to that described above for the detecting circuits 8a, the disable signal generation circuits 9a, the therapeutic energy signal generation circuits 5a, and the percutaneous therapeutic units 2a, 2b.

In the second control circuit for the present invention, there are ten percutaneous therapeutic units 2a to 2j that are grouped into five groups, such that each of the five groups consisting of two percutaneous therapeutic units 2a & 2b, 2c & 2d, 2e & 2f, 2g & 2h, and 2i & 2j. These five groups of two percutaneous therapeutic units 2a & 2b, 2c & 2d, 2e & 2f, 2g & 2h, and 2i & 2j are connected to the five therapeutic energy signal generation circuits 5a to 5e, respectively. Of course, the therapeutic energy signal generation circuits may be connected to the percutaneous therapeutic units in other manners. For example, each of the therapeutic energy signal generation circuits may be connected to only one single percutaneous therapeutic unit. Alternatively, when the holder 1 has a quite large number of percutaneous therapeutic units held thereon, the percutaneous therapeutic units may be grouped into more groups with each group consisting of three, four, five, or more percutaneous therapeutic units while each group of percutaneous therapeutic units being connected to and driven by a separate therapeutic energy signal generation circuit.

The percutaneous therapeutic apparatus 100 is also helpful in the oozing of a medicament applied on the skin, such as an anti-inflammatory drug, a chemically active compound or a product thereof for slimming or fat burning, etc., into the user's body to achieve the effect of therapy, burning fats, or losing weight. Moreover, the percutaneous therapeutic apparatus 100 enables switching among different percutaneous therapeutic units at preset regular intervals, so that at least two percutaneous therapeutic units are driven each time to output therapeutic energy to different areas on the user's body.

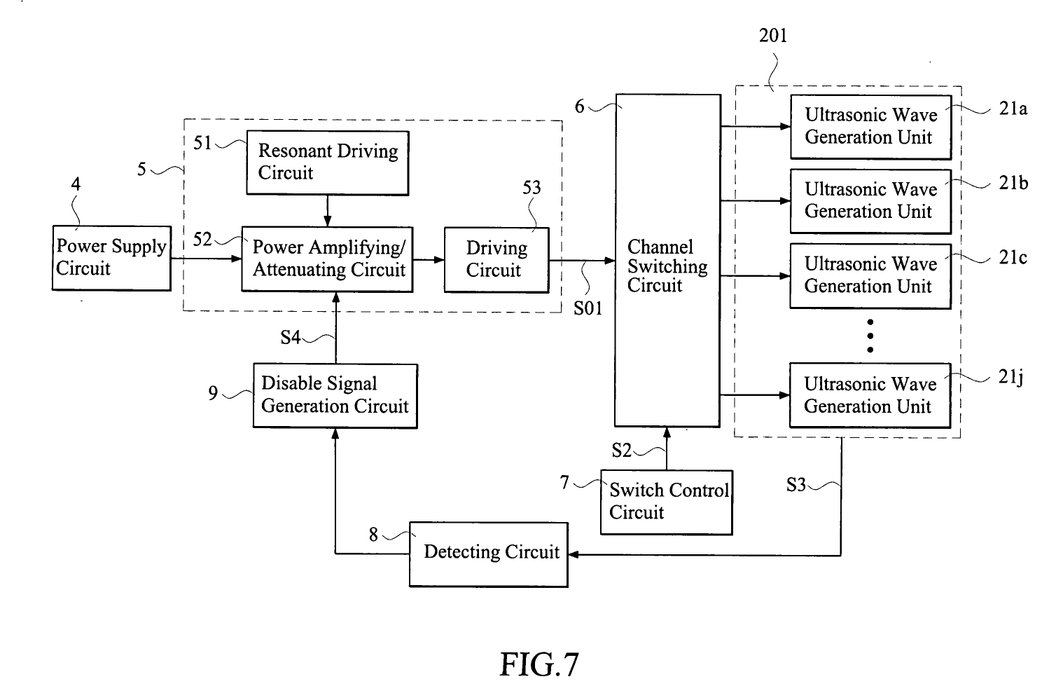

Please refer to FIG. 7 that is a block diagram showing a first embodiment of the present invention adopting the first control circuit. As shown, the control circuit of FIG. 7 is generally similar to that of FIG. 5. Therefore, parts that are similar in the two control circuits are denoted by the same reference numerals. In the first embodiment of the present invention, the percutaneous therapeutic units of the percutaneous therapeutic apparatus are a plurality of ultrasonic wave generation units 21a to 21j that together form a ultrasonic wave array 201 and output ultrasonic wave energy as the therapeutic energy; and the therapeutic energy signal generation circuit is a ultrasonic wave signal generation circuit 501 that generates a ultrasonic wave output signal S01 as the therapeutic energy output signal.

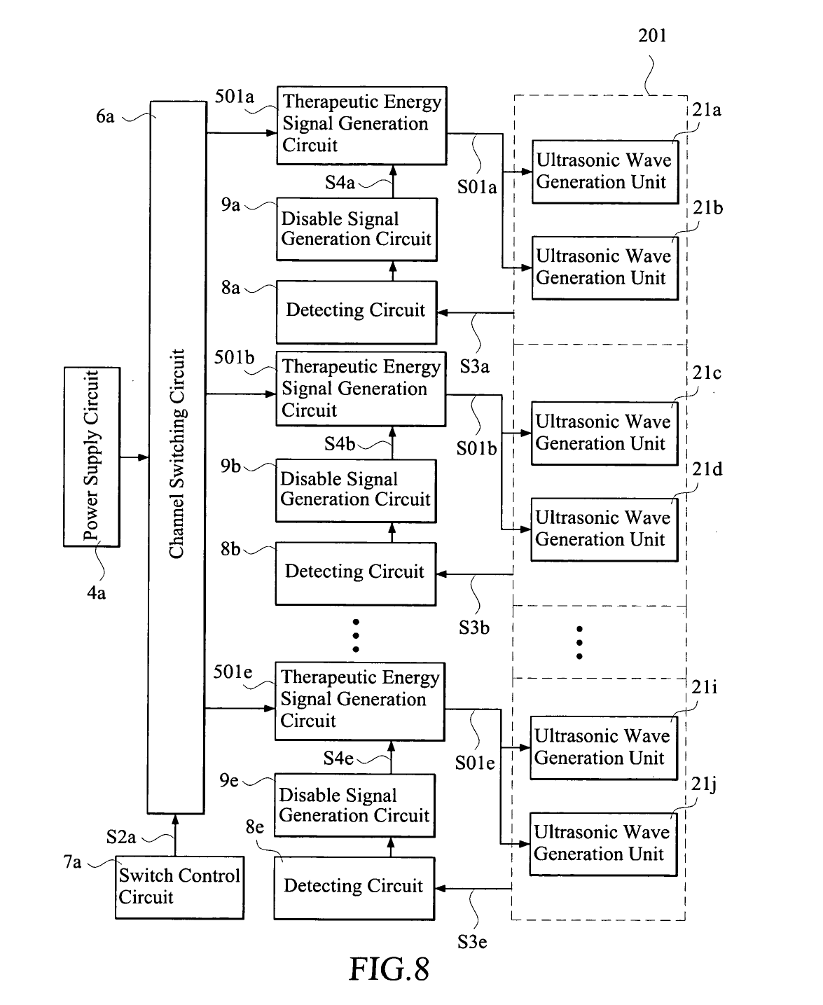

Please refer to FIG. 8 that is a block diagram showing the first embodiment of the present invention adopting the second control circuit. As shown, the control circuit of FIG. 8 is generally similar to that of FIG. 6. Therefore, parts that are similar in the two control circuits are denoted by the same reference numerals. In the second control circuit for the first embodiment of the present invention, the percutaneous therapeutic units of the percutaneous therapeutic apparatus are a plurality of ultrasonic wave generation units 21a to 21j that together form a ultrasonic wave array 201, and the therapeutic energy signal generation circuits 501a to 501e generate ultrasonic wave output signals S01a to S01e to the ultrasonic wave generation units 21a to 21j, respectively.

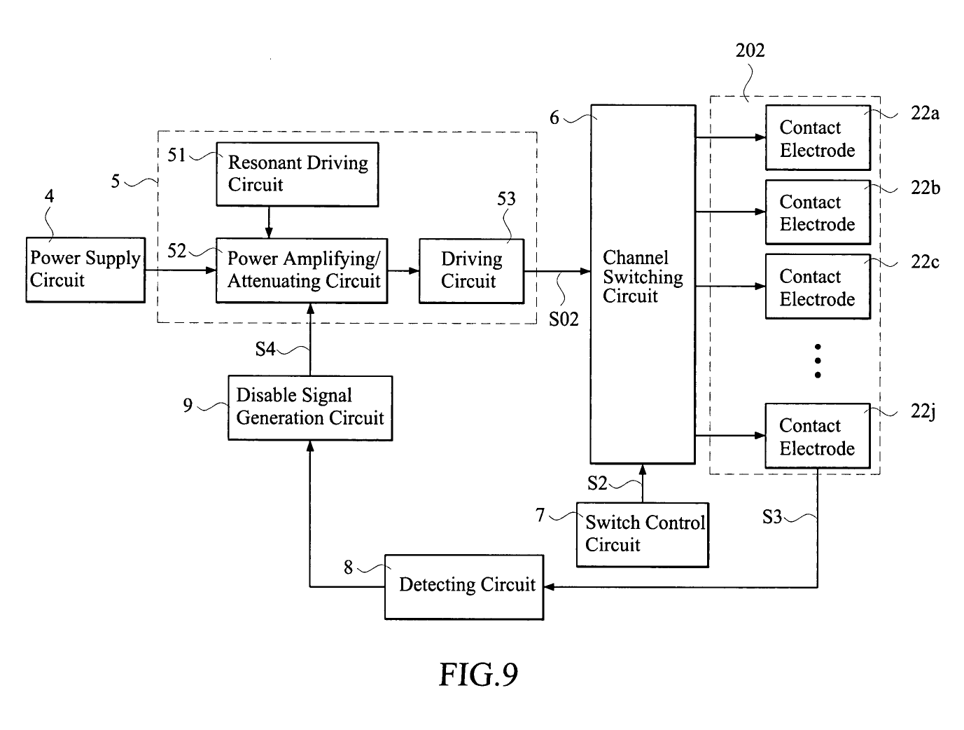

Please refer to FIG. 9 that is a block diagram showing a second embodiment of the present invention adopting the first control circuit. As shown, the control circuit of FIG. 9 is generally similar to that of FIG. 5. Therefore, parts that are similar in the two control circuits are denoted by the same reference numerals. In the second embodiment of the present invention, the percutaneous therapeutic units of the percutaneous therapeutic apparatus are a plurality of contact electrodes 22a to 22j that together form an contact electrode array 202 and output electric energy as the therapeutic energy; and the therapeutic energy signal generation circuit is an electrically conducting signal generation circuit 502 that generates an electric energy output signal S02 as the therapeutic energy output signal to the contact electrodes 22a to 22j via the channel switching circuit 6. The contact electrodes 22a to 22j are made of an electrically conductive material, such as carbon, metal powder or particulates, including gold, silver, copper, iron, or other electrically conductive substances, an electrically conductive cloth, or an electrically conductive fiber. In the second embodiment of the present invention, the contact electrodes 22a to 22j held on the holder 1 are spaced and insulated from one another by a plurality of insulating regions 13 on the holder 1, as shown in FIG. 4.

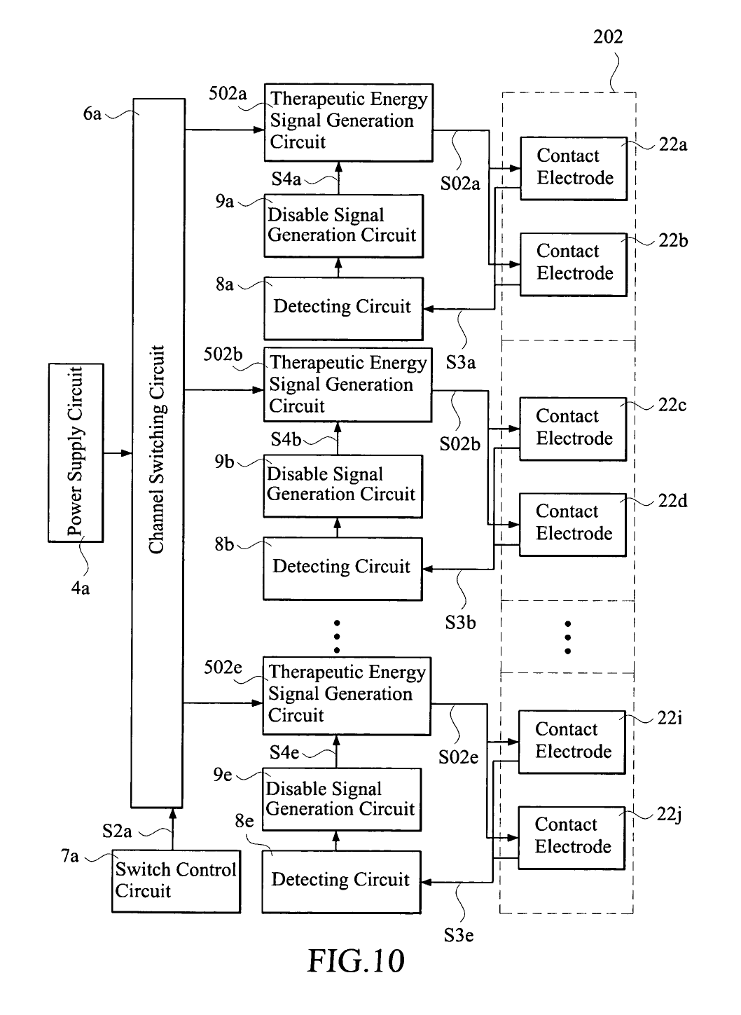

Please refer to FIG. 10 that is a block diagram showing the second embodiment of the present invention adopting the second control circuit. As shown, the control circuit of FIG. 10 is generally similar to that of FIG. 6. Therefore, parts that are similar in the two control circuits are denoted by the same reference numerals. In the second control circuit for the second embodiment of the present invention, the percutaneous therapeutic units of the percutaneous therapeutic apparatus are a plurality of contact electrodes 22a to 22j that together form an contact electrode array 202 and output electric energy as the therapeutic energy; and the therapeutic energy signal generation circuits are electrically conducting signal generation circuits 502a to 502e to generate electric energy output signals S02a to S02e as the therapeutic energy output signals, respectively.

Although the present invention has been described with reference to the preferred embodiments thereof, as well as the best mode for carrying out the present invention, it is apparent to those skilled in the art that a variety of modifications and changes may be made without departing from the scope of the present invention which is intended to be defined by the appended claims.

What is claimed is:

1. A percutaneous therapeutic apparatus for performing a percutaneous therapy at selected areas on a user's body, comprising:
a holder having an insertion face;
a plurality of percutaneous therapeutic units separately inserted on the insertion face of the holder for contacting with the user's skin at the selected areas and outputting therapeutic energy thereto.

2. The percutaneous therapeutic apparatus as claimed in claim 1, further comprising a belt connected to two lateral ends of the holder for binding the holder to the user's body with the percutaneous therapeutic units inserted on the holder contacting with the user's skin at the selected areas, so that the percutaneous therapeutic units may output the therapeutic energy to the selected areas.

3. The percutaneous therapeutic apparatus as claimed in claim 1, wherein the holder is made of a flexible material.

4. The percutaneous therapeutic apparatus as claimed in claim 1, wherein the percutaneous therapeutic units are ultrasonic wave generation units to output ultrasonic wave energy to the selected areas on the user's body as the therapeutic energy.

5. The percutaneous therapeutic apparatus as claimed in claim 1, wherein the percutaneous therapeutic units are contact electrodes to output electric energy to the selected areas on the user's body as the therapeutic energy; and wherein the contact electrodes are made of an electrically conductive material, and the holder includes a plurality of insulating regions to electrically insulate the contact electrodes from one another.

6. The percutaneous therapeutic apparatus as claimed in claim 1, further comprising a control circuit for controlling the percutaneous therapeutic units to operate; the control circuit comprising a therapeutic energy signal generation circuit for generating a therapeutic energy output signal, a channel switching circuit connected to and between the therapeutic energy signal generation circuit and each of the percutaneous therapeutic units, and a switch control unit connected to and controlling the channel switching circuit for at least one of the percutaneous therapeutic units to connect to the therapeutic energy signal generation circuit and thereby be driven by the therapeutic energy output signal to output the therapeutic energy.

7. The percutaneous therapeutic apparatus as claimed in claim 6, wherein the control circuit further comprises a detecting circuit and a disable signal generation circuit; the detecting circuit being connected to and between the disable signal generation circuit and each of the percutaneous therapeutic units for receiving an overheating signal output by an overheated one of the percutaneous therapeutic units and transferring the received overheating signal to the disable signal generation circuit; and the disable signal generation circuit being connected to the therapeutic energy signal generation circuit for sending a disable signal generation signal to the therapeutic energy signal generation circuit on receipt of the overheating signal, so that the therapeutic energy signal generation circuit stops generating the therapeutic energy output signal.

8. The percutaneous therapeutic apparatus as claimed in claim 7, wherein the percutaneous therapeutic units are ultrasonic wave generation units that output ultrasonic wave energy as the therapeutic energy; and wherein the therapeutic energy signal generation circuit is a ultrasonic wave signal generation circuit that generates ultrasonic wave output signal as the therapeutic energy output signal.

9. The percutaneous therapeutic apparatus as claimed in claim 7, wherein the percutaneous therapeutic units are contact electrodes that output electric energy as the therapeutic energy; and wherein the therapeutic energy signal generation circuit is an electrically conducting signal generation circuit that generates an electric energy output signal as the therapeutic energy output signal.

10. The percutaneous therapeutic apparatus as claimed in claim 1, further comprising a control circuit for controlling the percutaneous therapeutic units to operate; the control circuit including at least two therapeutic energy signal generation circuits, a channel switching circuit, and a switch control circuit; each of the therapeutic energy signal generation circuits being connected to at least one of the percutaneous therapeutic units and generating a therapeutic energy output signal to drive the percutaneous therapeutic unit connected thereto to output the therapeutic energy; the channel switching circuit being connected to each of the therapeutic energy signal generation circuits; and the switch control unit being connected to the channel switching circuit for setting switching intervals and switching sequence for the channel switching circuit to switch among the therapeutic energy signal generation circuits at the intervals and in the sequence preset via the switch control unit.

11. The percutaneous therapeutic apparatus as claimed in claim 10, wherein the control circuit further includes at least two detecting circuits and at least two disable signal generation circuits; the percutaneous therapeutic units connected to each of the therapeutic energy signal generation circuits being separately connected to one of the detecting circuits, the two detecting circuits being separately connected to one of the disable signal generation circuits, and the disable signal generation circuits being separately connected to one of the therapeutic energy signal generation circuits; and wherein each of the detecting circuits is able to receive an overheating signal output by an overheated one of the percutaneous therapeutic units connected thereto and transfers the received overheating signal to the disable signal generation circuit connected thereto, and the disable signal generation circuit sends a disable signal generation signal to the connected therapeutic energy signal generation circuit on receipt of the overheating signal, so that the therapeutic energy signal generation circuit stops generating the therapeutic energy output signal.

12. The percutaneous therapeutic apparatus as claimed in claim 11, wherein the percutaneous therapeutic units are ultrasonic wave generation units that output ultrasonic wave energy as the therapeutic energy; and wherein the therapeutic energy signal generation circuits are ultrasonic wave signal generation circuits that generate ultrasonic wave output signal as the therapeutic energy output signal.

13. The percutaneous therapeutic apparatus as claimed in claim 11, wherein the percutaneous therapeutic units are contact electrodes that output electric energy as the therapeutic energy; and wherein the therapeutic energy signal generation circuits are electrically conducting signal generation circuits that generate an electric energy output signal as the therapeutic energy output signal.
